(19) United States
(12) Patent Application Publication
(10) Pub. No.: US 2026/0047552 A1
(43) Pub. Date: Feb. 19, 2026

(54) Clicker Ring

(71) Applicant: Michael Anthony Thomas, Manchester, NH (US)

(72) Inventor: Michael Anthony Thomas, Manchester, NH (US)

(73) Assignee: Flex Clicker LLC, Manchester, NH (US)

(21) Appl. No.: 18/665,645

(22) Filed: May 16, 2024

(51) Int. Cl. A01K 15/02

(52) U.S. Cl. CPC A01K 15/02

(57) ABSTRACT

The clicker ring is a novel device for training animals, providing a minimalist, simple, and effective solution for trainers. The wearable clicker ring design provides hands-free usage and immediate animal feedback in training. The device features a wearable design with an elastic rubber band for one-size-fits-all comfort, a snap-together assembly for easy manufacturing, a sound chamber with windows to amplify the clicking sound, and a button mechanism with a limited press depth to prevent damage to internal components. Being worn on their finger, the clicker allows the user to provide immediate feedback when training animals. Wearing the clicker also allows the user's hands to remain free for holding other items or performing other tasks.

The present utility patent application is related to the design disclosed in U.S. Design Pat. No. D998,915, which covers the ornamental design of the product.

### BACKGROUND ART

Training animals often involves the use of clicker devices to provide immediate feedback for desired behaviors. Traditional clickers are handheld devices with wrist straps, which can be cumbersome and restrict the trainer's movement during training sessions. Additionally, traditional clickers may not always provide the immediacy required for effective training.

The two dominant animal training clicker designs on the market are both handheld clickers with wrist straps. These clickers are an annoyance to have dangling from the user's wrist. The user must fumble to grab the wrist strap clicker each time they wish to provide training feedback to an animal. This requires additional effort from the user and also creates a delay in providing feedback to the animal. This delay in feedback is crucial, as the animal must be rewarded with a click immediately for good behavior. If too much time passes, the feedback window is lost.

### SUMMARY

The invention is a clicker ring designed for training various animals, including dogs, cats, horses, and others. This novel device offers a minimalist, simple, and effective solution for trainers by providing immediate feedback without restricting hand movement. The wearable clicker ring allows the user to provide more immediate feedback when training animals, as opposed to the wrist strap style. The ring style also allows the user's hands to remain free for holding other items or performing other tasks while training.

The clicker ring features a wearable design, an elastic rubber band for one-size-fits-all comfort, a snap-together assembly for easy manufacturing, a sound chamber with windows to increase click decibels, and a button with a limited press depth to prevent damage to internal components. The clicker ring consists of two ring halves, a button, a stretchy rubber band, and a piece of metal that clicks when flexed.

### BRIEF DESCRIPTION OF THE DRAWINGS

FIG. 1 is a front perspective view of the clicker ring;

FIG. 2 is a front side elevational view thereof, the back side being a mirror image;

FIG. 3 is a left side elevational view thereof, the right side being a mirror image;

FIG. 4 is a top plan view thereof;

FIG. 5 is a bottom plan view thereof; and

FIG. 6 is an exploded isometric view of the clicker ring.

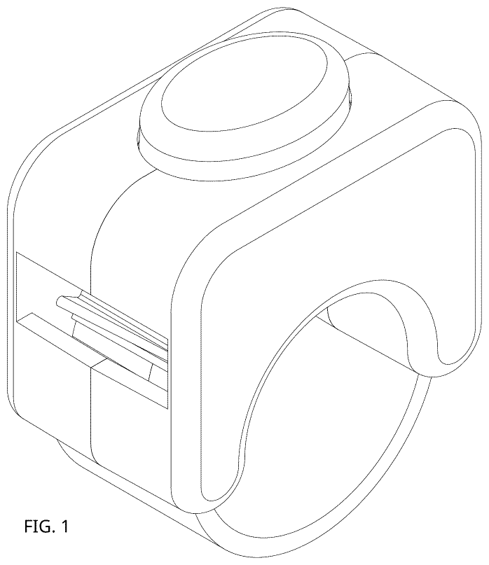

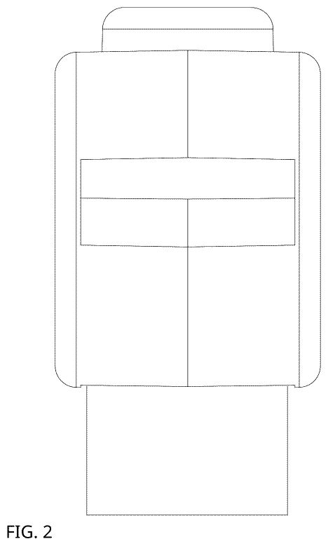

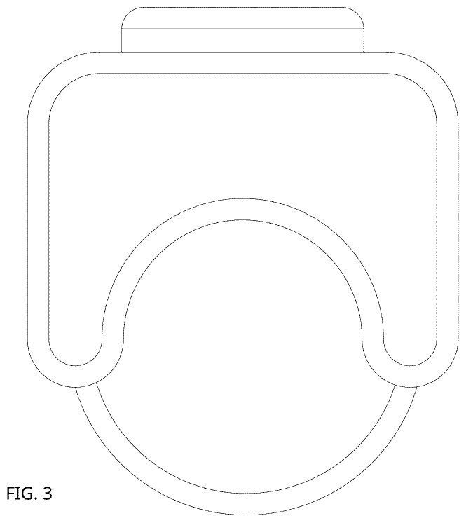

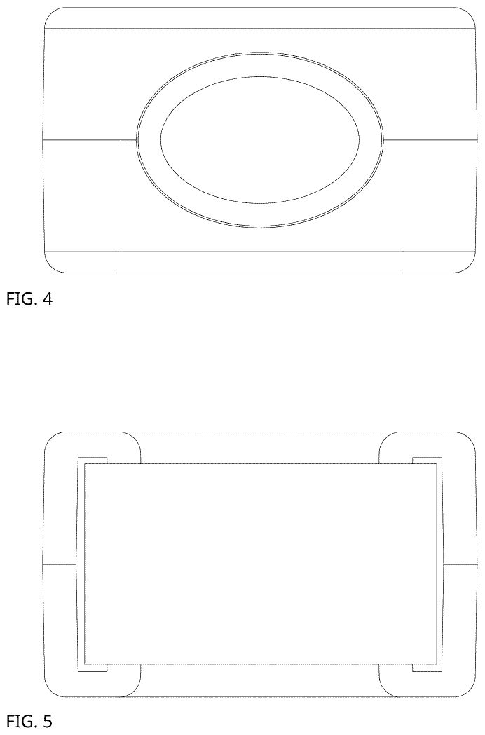

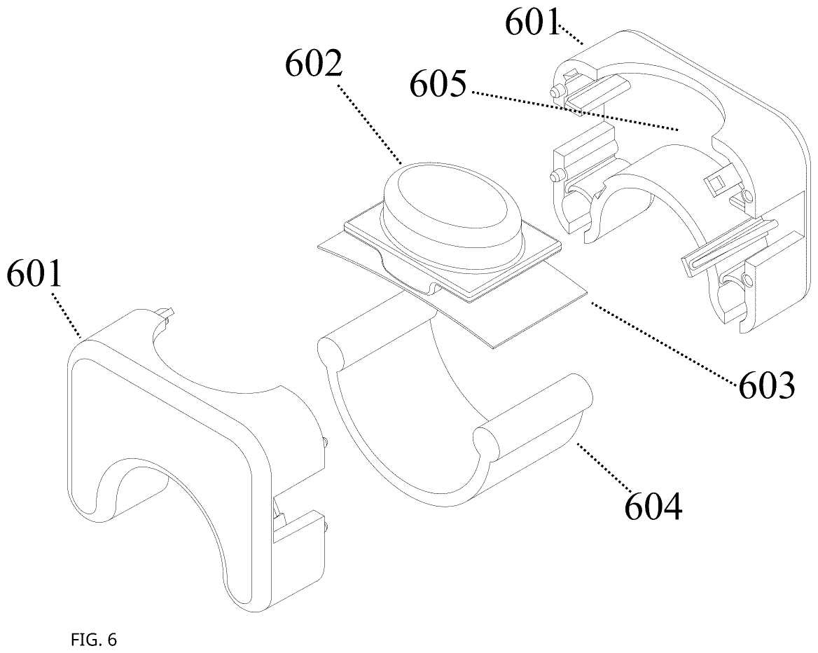

### DETAILED DESCRIPTION OF THE INVENTION

The clicker ring comprises a housing made of durable plastic 601. The housing contains the internal components of the clicker, including a piece of clicking metal 603, a sound chamber 605, a button mechanism 602, and an elastic rubber band 604.

The elastic rubber band 604 is installed inside the housing 601 and is designed to fit comfortably around the user's finger. The elasticity of the rubber band 604 allows for a one-size-fits-all design, accommodating fingers of various sizes without the need for adjustable straps or buckles, or the manufacturing of multiple ring sizes. This greatly simplifies manufacturing logistics.

The housing 601 features a snap-together design, allowing for ease of assembly during manufacturing. This design simplifies the production process and reduces manufacturing time and costs.

Within the housing 601, the sound chamber 605 is designed to amplify the clicking sound produced when the button 602 is pressed. The sound chamber 605 features strategically placed windows to increase the decibel level of the click, ensuring that it is audible to the animal being trained even in noisy environments.

The button mechanism 602 is designed to only be pressed down to a certain depth, preventing excessive force from damaging the internal components such as the metal clicking mechanism 603. This design feature enhances the durability and longevity of the clicker ring.

What is claimed is:

1) A wearable clicker device for training animals, comprising:
a) A wearable ring shape to provide hands-free operation and quick response times;
b) An elastic rubber band to facilitate a one-size-fits-all product to be worn on a finger;
c) A button mechanism within the housing for producing the clicking sound, including a limited press depth feature to prevent damage to internal components;
d) A snap-together design for ease of assembly during manufacturing;
e) An open sound chamber for amplifying resonance and decibels, including windows to increase the decibel level of the clicking sound.
